(19) United States
(12) Patent Application Publication
(10) Pub. No.: US 2025/0163788 A1
(43) Pub. Date: May 22, 2025

(54) MULTISTAGE COMPLETION TOOL

(71) Applicant: Tier 1 Energy Solutions, Inc., Edmonton (CA)

(72) Inventors: Jeffrey Golinowski, Edmonton (CA); Hassan Murched, Edmonton (CA); Sam Schroit, Houston, TX (US); Jeffrey Bruce Wensrich, Cypress, TX (US)

(21) Appl. No.: 18/954,059

(22) Filed: Nov. 20, 2024

Related U.S. Application Data
(60) Provisional application No. 63/601,856, filed on Nov. 22, 2023.

(51) Int. Cl. E21B 43/26; E21B 34/06; E21B 47/06; G08C 17/02

(52) U.S. Cl. CPC E21B 43/26; E21B 34/066; E21B 47/06; G08C 17/02; E21B 2200/06

(57) ABSTRACT

Disclosed examples generally relate to devices and methods for completing a production installation to perform multi-stage treatment of an oil and gas wellbore, such as multi-stage fracturing operations. In at least one example, a multipressure cycling completion tool is provided, for completing a wellbore comprising a plurality of downhole elements, each having a wireless tag, the tool comprising an activation assembly, comprising an activation motor, a transmission, a longitudinally moveable cone, and an expandable anchor ring and sealing element disposed around the cone, wherein the activation motor causes longitudinal movement of the cone, which causes expansion or retraction of the anchor ring and sealing element; a wireless sensor configured to detect, and optionally identify, a wireless tag associated with a downhole element; and a controller operatively connected to the wireless sensor and the activation assembly, and configured to actuate the activation assembly in response to sensing of a wireless tag.

### CROSS-REFERENCE TO RELATED APPLICATION(S)

The present application claims priority to, and the benefit of, U.S. Provisional Patent Application No. 63/601,856, titled “MULTISTAGE COMPLETION TOOL”, filed on Nov. 22, 2023, the entire contents of which are incorporated herein by reference.

### FIELD OF INVENTION

The present invention relates to devices and methods for completing a production installation to perform multi-stage treatment of an oil and gas wellbore, such as multi-stage fracturing operations.

### BACKGROUND

It is known to perform a staged treatment of oil and gas wellbores and the surrounding formations in two or more isolated zones or sections along the tubing, in what is known as “plug and perf”. This treatment involves perforating the wellbore casing with explosive charges and then placing a plug in each perforation to isolate one stage of the fracturing process, which is repeated for each stage. Alternatively, open hole methods using sliding sleeves may be provided on the tubing to selectively open and close the respective sections of perforations. The sliding sleeves may be actuated with a ball or a dart as is well known in the art.

In a ball-activated system, each sliding sleeve valve defines a ball seat designed to seat a ball of particular size but allow smaller balls to pass through the seat. The ball seat diameters are graduated such that the ball seat closest to the surface has the largest diameter and the ball seat furthest down the well has the smallest diameter.

In a typical operation, a ball having the appropriate size to seat at the selected valve is launched into the tubing string and passes through ball seats above the selected valve, but seats at the selected valve because the ball is too large to pass through the selected valve's ball seat. Pressure above the seated ball may then be increased to actuate the selected sliding sleeve valve. Balls of progressively larger sizes are used in series to actuate successive sliding sleeve valves up the string.

However, the number of ball-activated stages that can be used within a tubing string in series is limited by the need to size the balls and ball seats appropriately. As ball seat diameter decreases the flow restriction through the ball seat, thus there is a practical lower limit on the useable size of balls. Thus, current completion methods have limits to the number of stages that can be performed.

### SUMMARY

According to an embodiment, disclosed is a multipressure cycling completion tool, for completing a wellbore comprising a plurality of downhole elements, the tool comprising:
a. an activation assembly, comprising an activation motor, a transmission, a longitudinally moveable cone, and an expandable anchor ring and sealing element disposed around the cone;
b. a wireless sensor configured to detect, and optionally identify, a wireless tag associated with a downhole element; and
c. a controller operatively connected to the wireless sensor and the activation assembly, and configured to actuate the activation assembly in response to sensing of a wireless tag.

In preferred embodiments, the wireless sensor comprises an RFID sensor, the wireless tags comprise a passive or active RFID tag, and the downhole elements comprise a plurality of sliding sleeve valves which may be engaged by the completion tool. The sliding sleeve valves are installed in linearly spaced intervals along the wellbore. In one embodiment, the sliding sleeve valves may all include a valve seat which is the same size.

In another aspect, disclosed is a method of stimulating a wellbore in a subterranean formation, comprising a plurality of valves which may be opened downhole, each valve comprising or associated with a wireless tag, the method comprising the steps of:
a. Inserting a multipressure cycling completion tool having an activation assembly for activating and deactivating an expandable anchor ring and sealing element, the tool further comprising a wireless sensor configured to detect, and optionally identify, a wireless tag associated with a downhole valve; and a controller operatively connected to the wireless sensor and the activation assembly, and configured to actuate the activation assembly in response to sensing of a wireless tag;
b. Allowing the tool to pass through a predetermined number of valves until the tool reaches a selected valve;
c. Actuating the activation assembly such that the tool seats into the selected valve;
d. Opening the selected valve and conducting a stimulation of the formation through the open valve;
e. Deactivating the tool and allowing it to flow backwards past an uphole valve to be selected next; and
f. Repeating steps (c) and (d).

In some embodiments, the valve comprises a sliding sleeve valve and the stimulation is a fracturing operation.

In another aspect, disclosed herein is a method of engaging a downhole valve with a completion tool configured to engage the valve, wherein the valve comprises a wireless tag and the tool comprises a wireless tag reader, comprising the step of activating the tool such that it engages the valve after the tool senses that the tool has passed through the valve in an uphole direction.

In some embodiments, the valve is a sliding sleeve valve, and the tool has an expandable sealing element for engaging the sliding sleeve valve after expansion.

In some embodiments, the method comprises the further step of deactivating the tool after the valve has been opened and the tool senses that a downhole and a uphole pressure are substantially the same.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

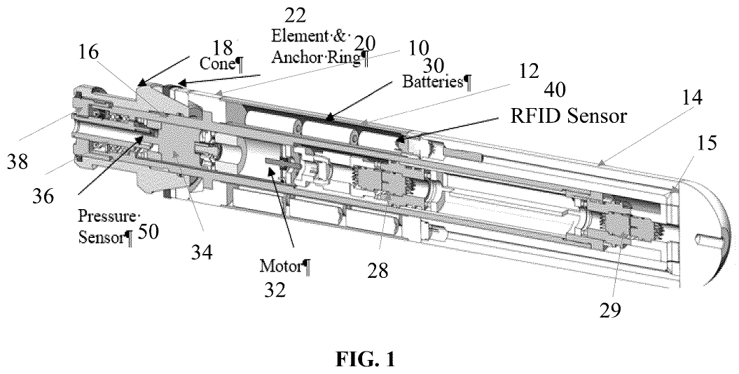

(a) FIG. 1 is a longitudinal cross-section of one embodiment of a multipressure cycling completion tool;

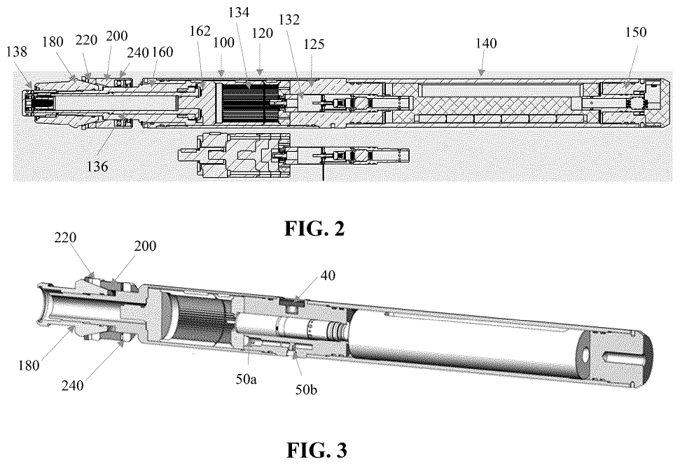

(b) FIG. 2 shows an alternative embodiment of a multipressure cycling completion tool, in longitudinal cross-section;

(c) FIG. 3 shows a partial cut-away view of the embodiment of FIG. 2;

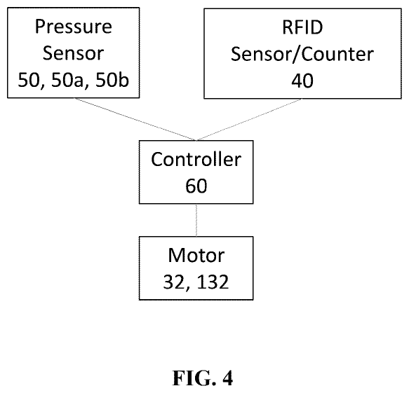

(d) FIG. 4 shows a schematic representation of the sensors and controller of an exemplary system;

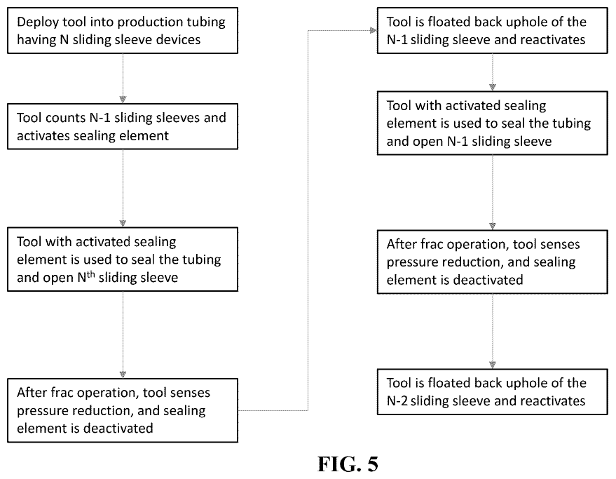

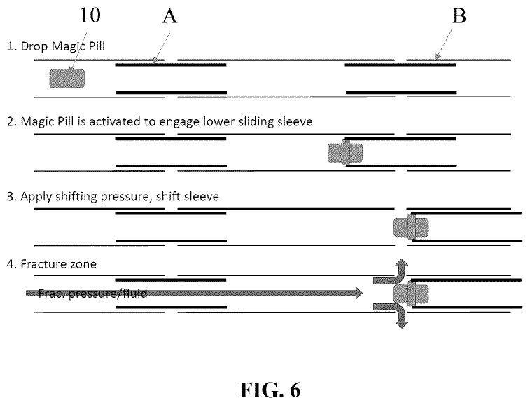

(e) FIG. 5 shows a schematic flowchart of one embodiment of a stimulation operation using a tool as described herein;

(f) FIG. 6 is a schematic depiction of deployment of the embodiment of FIG. 1 in a first stage frac operation; and

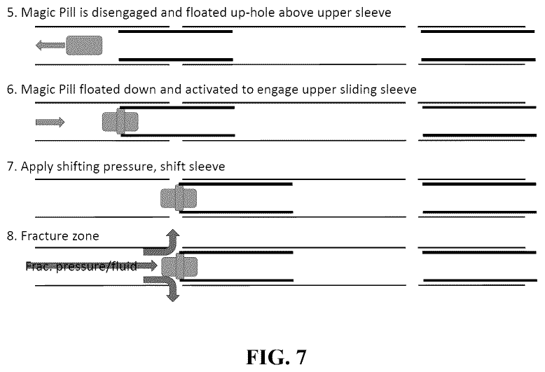

(g) FIG. 7 is a schematic depiction of deployment of the embodiment of FIG. 1 in a second stage frac operation, uphole from the first stage.

### DETAILED DESCRIPTION

The present invention now will be described more fully hereinafter with reference to the accompanying drawings, in which some, but not all embodiments of the invention are exemplified. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

In this description, the directional prepositions of up, upwardly, down, downwardly, front, back, top, upper, bottom, lower, left, right and other such terms may refer to the device as it is oriented and appears in the drawings and are used for convenience only; they are not intended to be limiting or to imply that the device has to be used or positioned in any particular orientation. The lower end of a downhole component is the downhole end inserted first into the wellbore, whether or not it is higher or lower in elevation than an uphole end. Conventional components of the invention are elements that are well-known in the prior art and will not be discussed in detail for this disclosure.

As used herein, a “frac” stimulation is a reference to “fracturing”, which is a known stimulation technique, well known and understood by those skilled in the art. Embodiments of a multistage completion tool described below may be used to complete an entire well in a plurality of stages. A single tool can be used to activate any number of downhole sleeves or clusters.

In some embodiments, the wellbore may be completed with the same size sliding sleeve valve for every stage, allowing for unlimited stages of either single or multipoint entry designs. As the sleeves are preferably identical, an operator need not be concerned with installing sleeves in the wrong order which is a risk with other completion systems that require size differentials between successive stages.

FIG. 1 illustrates one embodiment, where a multistage completion tool comprises a top sub 10, a motor housing 12, and a lower housing 14, connected together to form a cylindrical device defining an inner bore. A bottom cap attached to a bottom sub 15 seals the lower end of the lower housing 14. A mandrel 16 extends through the length of the device and encloses a motor 32 and transmission 34. A cone 18 and an expandable anchor ring 20 are disposed concentrically around the mandrel 16. An upper split ring 22 and a lower retaining ring 24 frame the expandable sealing element 20.

The activating assembly comprises the electric actuation motor 32 and a transmission 34 which includes a driveshaft 36 extending upwardly within the mandrel 16. The drive shaft 36 engages the top nut 38 which bears on the cone 18, which is slidingly disposed on the mandrel 16. An expandable anchor ring 22, which is preferably a split ring, and expandable sealing element 20 are disposed around the sloped outer surface of the cone 18. As may be seen, the cone 18 outside diameter increases towards the upper end of the tool (shown on the left hand side). Rotational movement of the activating assembly causes longitudinal movement of the top nut 38 and the cone 18.

Electrical connectors 28, 29 are provided to connect the device electronic components to surface equipment when at surface, to program the device and/or to download or upload data, information or programs.

The actuation motor 32 is an electric motor, and batteries 30, which may comprise lithium rechargeable batteries, are disposed in the annular space between the mandrel 16 and the motor housing housing 12. The motor is connected to the transmission 34 and the cone 18 to displace the cone longitudinally using suitable gears. The gearing must be suited to the torque available from the motor, and the torque required to move the cone and expand the split ring and sealing element 20. Thus, the motor and transmission are configured to drive the cone longitudinally downwards, thereby expanding the anchor ring 24 and elastomeric sealing element 20 outwards. The expanded anchor ring and sealing element achieve an outside diameter that securely engages a sliding sleeve to seal to the sleeve inside diameter and to be able to shift it.

The motor may then be reversed to move the top nut 38 and cone 18 upwards, allowing the anchor ring 24 and sealing element 26 to return to their reduced diameter size, in order to pass through the production tubing and sliding sleeves unimpeded.

FIGS. 2 and 3 illustrates an alternative embodiment, where a multistage completion tool comprises an upper housing 100, a motor housing 120, a sensor housing 125 and a lower housing 140, connected together to form a cylindrical device defining an inner bore. A bottom cap attached to a bottom sub 150 seals the lower end of the lower housing 140. A mandrel 160 is positioned within the upper housing and bears on a motor adapter 162. The motor 132 and transmission 134 are positioned within the motor housing 120. In FIG. 2, the motor and transmission are also shown separately. A cone 180 and an expandable anchor ring 200 are disposed concentrically around the mandrel 160. An upper split ring 220 and a lower retaining ring 240 frame the expandable sealing element 200.

The transmission 134 which includes a driveshaft 136 extending upwardly within the mandrel 160. The drive shaft 136 engages the top nut 138 which bears on the cone 180, which is slidingly disposed on the mandrel 160. An expandable anchor ring 220, which is preferably a split ring, and expandable sealing element 200 are disposed around the sloped outer surface of the cone 18. As may be seen, the cone 180 outside diameter increases towards the upper end of the tool (shown on the left hand side). Rotational movement of the activating assembly causes longitudinal movement of the top nut 138 and the cone 180.

Control of the actuation motor 132 is provided by an electronic logic controller 60 operatively connected to the motor and the sensors contained in the tool, configured to implement the logic described below or as needed or desired by one skilled in the art.

The tool comprises a wireless sensor 40 which includes a counter, the operation of which is described further below. The sensor/counter 40 detects downhole elements which include a tag that is detectable by the sensor/counter 40 and thus enables the tool to count the number of elements its passes as it descends or ascends in the wellbore, and optionally identify an element if the element has a uniquely identifying tag. In some embodiments (FIG. 4), the wireless sensor 40 is an RFID sensor which detects and counts RFID tags included in sliding sleeves in the wellbore. The tags may be passive RFID tags, or alternatively, may be powered active tags using a small internal battery, as are well known in the art.

In some embodiments, the tool is configured to be responsive to pressure changes, with at least one pressure sensor 50. The tool may be configured such that the tool is activated by any uphole pressure above an activation threshold, and retracted by any uphole pressure below a deactivation threshold. In some embodiments, the activation threshold and the deactivation threshold may be the same pressure.

In some embodiments, there are two pressure sensors (FIG. 4): an uphole pressure sensor 50A and a downhole pressure sensor 50B. The controller 60 may then control the actuation motor 32 when the two pressure sensors indicate a pressure differential or when the pressures are substantially the same. A large pressure differential will indicate that a frac operation is in progress uphole of the tool, and that the device should remain activated and sealed to the sliding sleeve. The lack of a pressure differential can indicate that a frac operation has ended and that flowback has started. The device may be deactivated only when there is a lack of pressure differential.

FIG. 5 shows an exemplary flowchart of operation of the tool. The tool is deployed into the production tubing once the tubing string has been installed and completed, ready for stimulation. The tubing string may comprise N number of sliding sleeve devices, deployed in regular intervals or zones along the horizontal length of the wellbore, where the last (Nth) device is at the toe end of the wellbore. As the tool moves towards the toe end, the wireless sensor 40 senses and counts each sliding sleeve that the tool passes through. When the tool counts N−1 devices, indicating it is between terminal (Nth) device and the penultimate (N−1) device. On this count, the tool can then activate. The expanded OD of the sealing element will then engage the terminal sliding sleeve, permitting shifting of the sleeve and sealing the tubing string. A fracturing operation can then take place.

After the frac operation, the tool pressure sensors sense a reduction in uphole pressure, or a decrease in uphole/downhole pressure differential, and the tool can then be deactivated to release the tool from the sliding sleeve. Frac flowback may float the tool back up through the penultimate (N−1) sleeve, which is sensed by the wireless sensor. The tool can then be reactivated so that it cannot pass upwards through the N−2 sleeve. The tool may then be pumped down to engage the N−1 sleeve, to seal and shift the sleeve. A second frac operation may then take place, and the tool subsequently deactivates and floats back through the N−2 sleeve to be positioned between N−2 and N−3 when it is reactivated to engage the N−2 sleeve. The process can then be repeated for each stage. The primary sensor in this operation is the wireless sensor which detects and counts the sliding sleeves that the tool passes through. Pressure sensor readings can confirm or verify that the operation is proceeding as intended.

FIGS. 6 and 7 depict one embodiment of an operation with one embodiment of a multistage completion tool. For simplicity, the downhole completion string is shown horizontally, with two sliding sleeves A, B, where B is downhole of A, equivalent to two completion stages. This operation may be expanded to any number of stages with a sliding sleeve device for each stage.

In a first step, the tool 10 is dropped or inserted into the production tubing at surface. Preferably, it is not attached to any wireline or tubing, however, in some embodiments it may be mounted to coil tubing and used to deploy and activate sliding sleeves. The tool 10 may descend by gravity or may be pumped down in conventional manner. The wireless sensor in the tool is active and detects and counts each sliding sleeve the tool 10 passes as it descends. In the simplified operation depicted, the tool 10 is configured to be activated after passing and counting one sliding sleeve A.

Once activated, the controller causes the motor to drive the cone under the anchor ring and sealing element, which are wedged outward. The anchor ring contacts the shift sleeve and when the wellbore is pressured up, the sliding sleeve is displaced in step 3. A frac stimulation may then be completed through the open sleeve in step 4.

A reduction in pressure will be detected by the pressure sensor, thereby signaling the motor to return the cone to its retracted position. The device 10 may then be floated back up hole through sleeve A. The wireless sensor will sense the tag associated with the first sliding sleeve A, and the device controller will again activate the motor to expand the anchor ring and sealing element. If there is another sliding sleeve uphole of sleeve A, then the device 1 will be unable to continue uphole. The surface operator may detect this moment with a pressure or flow interruption.

The device may then be floated or pumped back down to engage sliding sleeve A in step 6, which may then be opened in step 7. A frac stimulation may then be completed through open sliding sleeve A.

As can be appreciated by those skilled in the art, this process may be repeated for any number of stages. The multistage completion tool does not require well intervention by wireline or coil tubing to manipulate the wellbore prior or subsequent to a stimulation operation. The tool 10 can reduce complexities involved with wireline and coil tubing interventions, and may eliminate stuck tool strings, missed runs/incomplete runs and other limitations associated with extended lateral sections.

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

1. A multipressure cycling completion tool, for completing a wellbore comprising a plurality of downhole elements, each having a wireless tag, the tool comprising:
a. an activation assembly, comprising an activation motor, a transmission, a longitudinally moveable cone, and an expandable anchor ring and sealing element disposed around the cone, wherein the activation motor causes longitudinal movement of the cone, which causes expansion or retraction of the anchor ring and sealing element;
b. a wireless sensor configured to detect, and optionally identify, a wireless tag associated with a downhole element; and
c. a controller operatively connected to the wireless sensor and the activation assembly, and configured to actuate the activation assembly in response to sensing of a wireless tag.

2. The tool of claim 1, wherein the wireless sensor comprises an RFID sensor and the wireless tags each comprise a passive or active RFID tag.

3. The tool of claim 1, wherein the plurality of downhole elements comprise a plurality of sliding sleeve valves.

4. The tool of claim 1, wherein the tool further comprises at least one pressure sensor operatively connected to the controller, and the controller is configured to control the activation assembly upon receiving pressure data.

5. The tool of claim 4, wherein the at least one pressure sensor comprises an uphole pressure sensor and a downhole pressure sensor.

6. The tool of claim 5, wherein the tool is not physically connected to any surface equipment and is battery powered.

7. A method of stimulating a wellbore in a subterranean formation, comprising a plurality of valves which may be opened downhole, each valve comprising or associated with a wireless tag, the method comprising the steps of:
d. Inserting a multipressure cycling completion tool having an activation assembly for activating and deactivating an anchor ring and sealing element, the tool further comprising a wireless sensor configured to detect, and optionally identify, a wireless tag associated with a downhole valve; and a controller operatively connected to the wireless sensor and the activation assembly, and configured to actuate the activation assembly in response to sensing of a wireless tag;
e. Allowing the tool to pass through a predetermined number of valves until the tool reaches a selected valve;
f. Actuating the activation assembly such that the tool seats into the selected valve;
g. Opening the selected valve and conducting a stimulation of the formation through the open valve;
h. Deactivating the tool and allowing it to flow backwards past the valve to be selected next; and
i. Repeating steps (c) and (d).

8. The method of claim 7, wherein each valve comprises a sliding sleeve valve.

9. The method of claim 7, wherein the stimulation is a fracturing operation.

10. The method of claim 7, wherein each valve has the same size valve seat which engages the completion tool.

11. A method of engaging a downhole valve with a completion tool configured to engage the valve, wherein the valve comprises a wireless tag and the tool comprises a wireless tag reader, comprising the step of activating the tool such that it engages the valve after the tool senses that the tool has passed through the valve in an uphole direction.

12. The method of claim 10, wherein the valve is a sliding sleeve valve, and the tool has an expandable sealing element for engaging the sliding sleeve valve after expansion.

13. The method of claim 11, comprising the further step of deactivating the tool after the valve has been opened and the tool senses that a downhole and a uphole pressure are substantially the same.
